(19) United States
(12) Patent Application Publication
(10) Pub. No.: US 2014/0322375 A1
(43) Pub. Date: Oct. 30, 2014

(54) ANGLED-OUTWARD TOGGLE CLAMPING TYPE VERTICAL INJECTION MOLDING MACHINE

(71) Applicant: JUI-HSIANG WANG, TAINAN CITY (TW)

(72) Inventor: JUI-HSIANG WANG, TAINAN CITY (TW)

(73) Assignee: HWA Chin Machinery Factory Co., Ltd., Tainan City (TW)

(21) Appl. No.: 13/871,181

(22) Filed: Apr. 26, 2013

(51) Int. Cl. B29C 45/66

(52) U.S. Cl. CPC B29C 45/661; B29C 2045/664
USPC 425/150

(57) ABSTRACT

An angled-outward toggle clamping type vertical injection molding machine is provided, in which a stationary platen is provided on a frame and a toggle mechanism is provided below the stationary platen. A coupling seat pivotally connected with the toggle arms of the toggle mechanism is fixed with tie bars which extend over above the stationary platen to assemble with the movable platen. An upper die and a lower die are respectively assembled to the movable platen and the stationary platen. When the toggle mechanism drives to open or clamp the dies, the clamping force of the dies can be increased and the action force of the toggle arms in their centered position is dispersed at two sides of the stationary platen so as to protect the stationary platen from deforming or damaging.

### BACKGROUND OF THE INVENTION

1. Field of the Invention

This invention relates to an angled-outward toggle clamping type injection molding machine, more particularly to an angled-outward toggle clamping type injection molding machine that not only can increase clamping force of upper and lower dies but also can effectively protect a stationary platen from deforming or damaging.

2. Brief Description of Prior Art

Referring to a Taiwanese Patent Gazette No. 569930 entitled “Double shot mould shift vertical type injection molding machine”, in which a central hydraulic cylinder is used to apply pressure directly to the movable platen so as to conduct opening or clamping of die relative to the stationary platen. As the clamping force is mainly obtained from the output of the hydraulic cylinder, the clamping force is inferior so that the product injected is liable to have defects and low quality. Further, the opening stroke is limited by the length of the output rod of the hydraulic cylinder that is almost set according to its specification. If a lengthwise product is to be injected, the vertical type injection molding machine of the Taiwanese Patent Gazette No. 569930 is not adaptable to the production of the lengthwise product due to its insufficiency in opening stroke.

Therefore, a toggle clamping type vertical injection molding machine has been proposed by some industries, such as the one disclosed in Taiwanese Patent Gazette No. 200639039 entitled “Vertical injection molding machine and its injection molding method”, in which an angled-inward toggle mechanism is utilized to conduct opening and clamping of upper and lower dies. The angled-inward toggle mechanism can increase the clamping force of the dies and the opening stroke, but when the angled-inward toggle mechanism pushes the toggle arms which are connected pivotally to the middle portion of the lower die into their centered position to clamp the dies, as the clamping force is concentrated at the middle portion of the lower die, the dies are easily deformed and even damaged. Moreover, in the vertical injection molding machine disclosed in the Taiwanese Patent Gazette No. 200639039, the sprue of the hot runner is provided at lateral side of the upper die and the hot runner is extended from the lateral side to the interior of the upper die and then turned downward in right angle to the die cavity so as to form a L shape hot runner. However, it is not easy to mold the product with an L shape hot runner and the die cost is also increased. Furthermore, the L shape hot runner may cause difficulties in the flow of melted plastic material and this may lead to quality defects of injected product. Moreover, the power device of the above vertical injection molding machine disclosed in the Taiwanese Patent Gazette No. 200639039 is a motor assembled at the side of the base, and the power is transmitted through belt to drive the angled-inward toggle mechanism. The power device not only takes a lot of space but also power loss will be resulted from indirect transmission through belt to the clamping mechanism.

### SUMMARY OF THE INVENTION

The main object of this invention is to provide a angled-outward toggle clamping type vertical injection molding machine that can increase clamping force of upper and lower dies, and protect a stationary platen from deforming and damaging.

In order to achieve above object, the inventor of the present invention proposes an angled-outward toggle clamping type vertical injection molding machine of the present invention, in which a stationary platen is provided on a frame and a toggle mechanism is provided below the stationary platen. Further, the coupling seat pivotally connected with the toggle arms of the toggle mechanism is fixed with tie bars which extend further to be above the stationary platen so as to couple with the movable platen. Further, upper and lower dies are respectively assembled to the movable and the stationary platens.

In this manner, when the toggle mechanism drives the upper and lower dies on the movable and the stationary platens to open or to clamp the dies, the clamping force between the dies can be increased, and the action force of the toggle arms in centered state is dispersed to the two sides of the stationary platen, so as to protect the stationary platen from deforming or damaging.

### BRIEF DESCRIPTION OF THE DRAWINGS

FIG. 1 is a front view of the present invention.

FIG. 2 is a bottom view of the die shift device of the present invention.

FIG. 3 is a top view of the stroke adjustment device of the present invention.

FIG. 4 is a view showing the state of usage of the present invention.

### DETAILED DESCRIPTION OF THE PREFERRED EMBODIMENTS

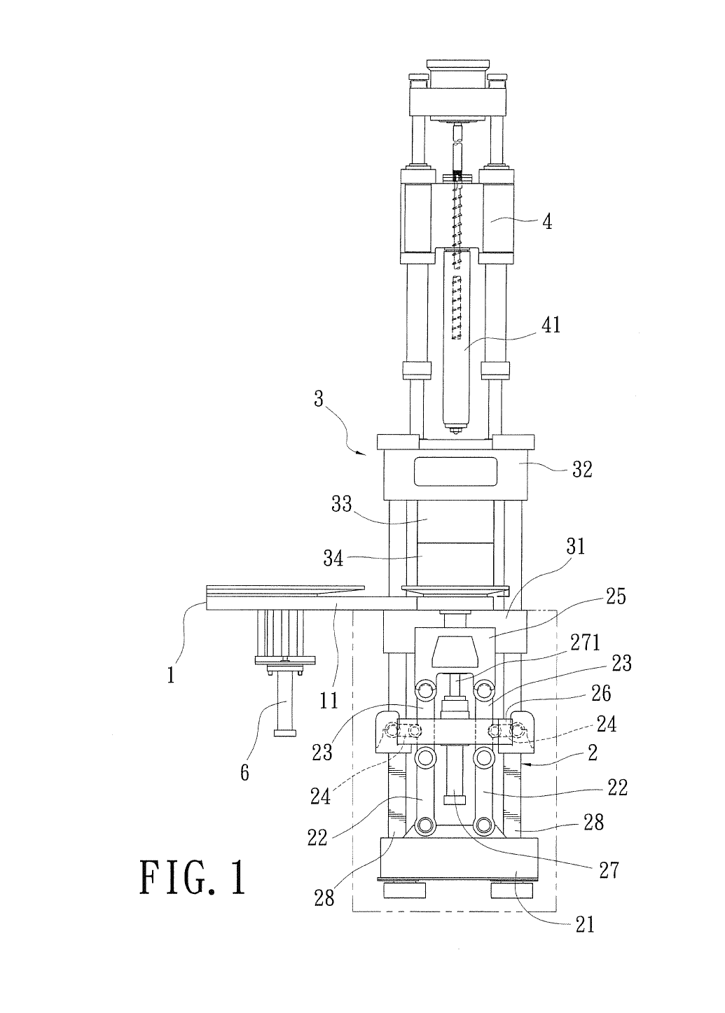

Firstly referring to FIG. 1, the angled-outward toggle clamping type vertical injection molding machine of the present invention is formed by a frame (1), an angled-outward toggle mechanism (2), a die unit (3), an injection unit (4), a die-shift unit (5), an ejector unit (6) and a stroke adjustment unit (7).

The frame (1) has a platen support (11) provided thereon at appropriate place.

The angled-outward toggle mechanism (2) includes a first coupling seat (21) both sides of which are pivotally connected respectively to one ends of corresponding first toggle arms (22). The other ends of both first toggle arms (22) are pivotally connected respectively to one ends of corresponding second toggle arms (23), and the other ends of both second toggle arms (23) are pivotally connected respectively to a second coupling seat (25). Furthermore, the second toggle arms (23) respectively are pivotally connected with one ends of corresponding third toggle arms (24) on appropriate places, and the other ends of the third toggle arms (24) are pivotally connected respectively to the two sides of an interlocking seat (26) which is fixed with a hydraulic cylinder (27) at the middle portion thereof. The end of an output rod (271) of the hydraulic cylinder (27) is fixed to the second coupling seat (25). One ends of tie bars (28) are correspondingly fixed to the two sides of the first coupling seat (21), and the other ends of the tie bars (28) are extended upward to pass through and fit in the interlocking seat (26), and then to pass out of a stationary platen (31) and the platen support (11) so as to be located above the platen support (11).

The die unit (3) includes a stationary platen (31), a movable platen (32), an upper die (33) and a lower die (34). The stationary platen (31) is fastened to the platen support (11) of the frame (1), and the second coupling seat (25) of the angled-outward toggle mechanism (2) is fixed to the bottom end of the stationary platen (31) so as to be integral therewith. The movable platen (32) has bush apertures (321) provided at four corners thereof for fitting with the other ends of the tie bars (28) which are protruded above the platen support (11). The bottom end of the movable platen (32) is fixed to the upper die (33), and the lower die (34) is installed at the upper end of the stationary platen (31) so as to correspond to the upper die (33).

The injection unit (4) is assembled to be above the movable platen (32) in such a manner that the nozzle of its barrel (41) corresponds to the sprue of upper die (33).

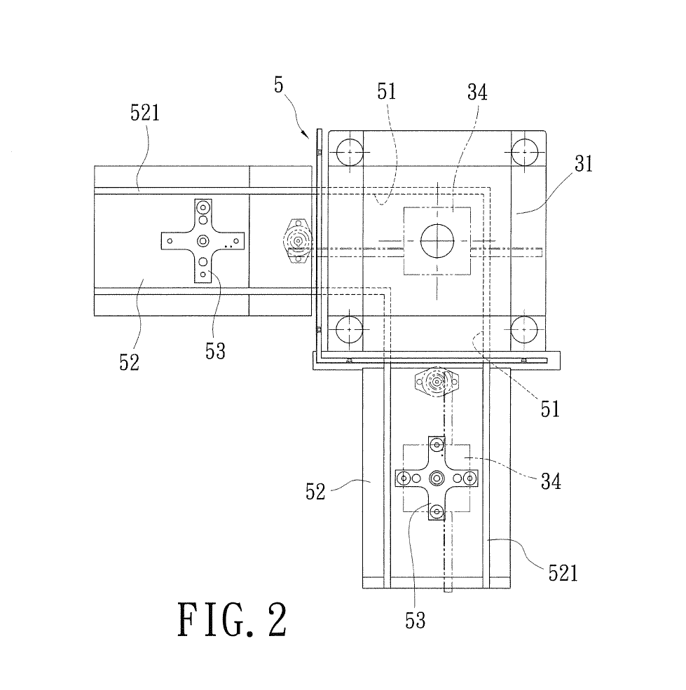

A die shift device (5), as shown in FIG. 2, includes at least two slide channels (51) formed on the upper end of the stationary platen (31) and the intersection of these at least two slide channels (51) corresponds precisely to the position of the upper die (33) so that the lower die (34) can positioned at that intersection to correspond to the upper die (33). Furthermore, the platen support (11) is formed with transport platforms (52) having slide channels (521) formed thereon, and the slide channels (521) of the transport platforms (52) are respectively aligned with the slide channels (51) of the stationary platen (31). Each of the transport platforms (52) carries one lower die (34), and each of the transport platforms (52) is connected with a displacement power unit (53) which can be a hydraulic cylinder.

The ejector units (6) are installed respectively at the slide channels (521) of the transport platforms (52) and are located below the transport platforms (52), so as to push the final molded product out of the lower die (34).

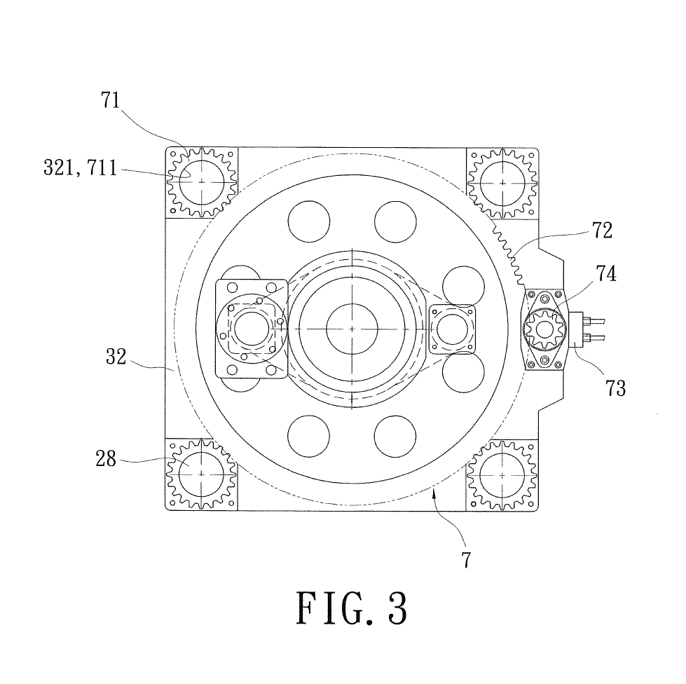

The stroke adjustment unit (7), as shown in FIG. 3, is assembled at the upper end of the movable platen (32), and the stroke adjustment unit (7) includes driven gears (71) respectively assembled in the bush apertures (321) where the tie bars (28) fit in the movable platen (32). The central apertures (711) of the driven gears (71) correspond respectively to the bush apertures (321) of the movable platen (32). Inner threaded segments are provided respectively within the central apertures (711) that are meshed respectively with outer threaded segments formed on the tie bars (28). The movable platen (32) is assembled with a drive gear (72) provided at the middle of the driven gears (71) and mated therewith. Further, a rotational power source (73) is provided on the movable platen (32) the output shaft of which is assembled with a transmission gear (74) for mating with the drive gear (72).

The operation of the present invention will be described according to the above configuration. Referring to FIG. 1, the hydraulic cylinder (27) of the angled-outward toggle mechanism (2) is actuated firstly so that the output rod (271) of the hydraulic cylinder (27) pushes against the second coupling seat (25). As the second coupling seat (25) is fixed to the stationary platen (31) that is kept in stationary state, the interlocking seat (26) fixed to the hydraulic cylinder (27) will displace downward by the push action of the output rod (271) of the hydraulic cylinder (27). In turn, the third toggle arms (24) pivotally linked with the interlocking seat (26) are also moved, so that the second toggle arms (23) pivotally linked with the third toggle arms (24) are towed thereby so as to move inwardly from angled outward position to centered position. The displacement of the second toggle arms (23) inwardly to the centered position also synchronously moves the first toggle arms (22) pivotally linked at one ends therewith from angled outward position inwardly to their centered position. When the first toggle arms (22) displaces inwardly to the centered position, the first coupling seat (21) pivotally linked at one ends with the first toggle arms (22) is pushed to displace downward so that the tie bars (28) fixed therewith are also move downward. Simultaneously, the movable platen (32) fixed with the tie bars (28) and the upper die fixed on the movable platen (32) are synchronously displaced downward so as to allow the upper die (33) move forward to the lower die (34). When the second and the first toggle arms (23), (22) are completely in the centered position, the first coupling seat (21) pivotally linked with the first toggle arms (22) also moves the upper die (33) fixed on the movable platen (32) along the tie bars (28) to mate with the lower die (34) so as to clamp the upper and lower dies (33), (34).

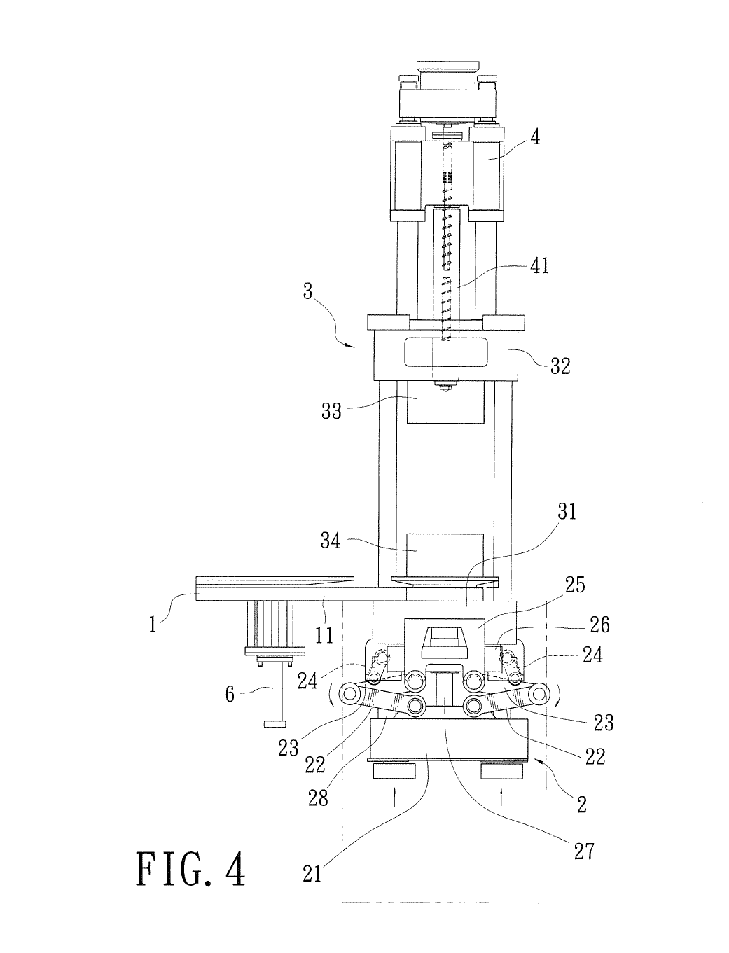

Next, the injection unit (4) mounted above the movable platen (32) carries out injection action so as to inject the molten plastic material from the nozzle of the barrel (41) through the spree of the upper die (33) to the mould cavity formed by the upper and lower dies (33), (34). After the molten plastic material is cooled down in the mould cavity, referring to FIG. 4, the hydraulic cylinder (27) of the angled-outward toggle mechanism (2) is actuated again to retract the output rod (271) of the hydraulic cylinder (27). As the second coupling seat (25) is fixed to the stationary platen (31), the interlocking seat (26) fixed to the hydraulic cylinder (27) will displace upward by the retraction of the output rod (271). In turn, the third toggle arms (24) pivotally linked with the interlocking seat (26) are also moved simultaneously, so that the second toggle arms (23) pivotally linked with the third toggle arm (24) are towed thereby so as to move from their centered position outwardly to the angled outward position. The outward displacement of the second toggle arms (23) to the angled outward position also synchronously moves the first toggle arms (22) pivotally linked at one ends therewith from the centered position outwardly to its angled outward position. When the first toggle arms (22) displaces outwardly to their angled outward position, the first coupling seat (21) pivotally to linked at one ends with the first toggle arms (22) is pushed to displace upward so that the tie bars (28) fixed therewith are also move upward. At the same time, the movable platen (32) fixed with the tie bars (28) and the upper die (33) fixed on the movable platen (32) are synchronously displaced upward so as to allow the upper die (33) detach from the mating with the lower die (34). When the output rod (271) of the hydraulic cylinder (27) is completely retracted, the movable platen (32) and the upper die (33) attached thereto are also retracted along the tie bars (28) so as to open the upper and lower dies (33), (34).

Next, referring to FIG. 2, one displacement power source (53) of the die shift unit (5) is started to move the lower die (34) out along the slide channel (51) on the stationary platen (31) and successively along the slide channel (521) of the transport platform (52) of the platen support (11). After the lower die (34) is moved to be positioned on the transport platform (52), the ejector unit (6) assembled below the transport platform (52) pushes the final molded product out of the lower die (34). When one displacement power source (53) of the die shift unit (5) is started to move the lower die (34) out of the mating with upper die (33), the other one displacement power source (53) of the die shift unit (5) is started to move the other lower die (34) mounted on its transport platform (52) along the slide channel (51) thereon and successively along the slide channel (51) of the stationary platen (31) and into the position corresponding to the upper die (33). Then, the die clamping and the injection are sequentially conducted. Whereby, as at least two lower dies (34) are alternately used to conduct injection, the waiting time for taking out the final product from the lower die (34) can be saved and thus the efficiency of injection molding is significantly increased.

Moreover, if users want to adjust the opening stroke to cope with the height of final product, referring to FIG. 3, the rotational power source (73) of the stroke adjustment unit (7) assembled on the movable platen (32) is started so that the transmission gear (74) assembled on the output rod thereof will mesh the drive gear (72) to rotate. In turn, the drive gear (72) meshes all the driven gears (71) to rotate. At this moment, the inner thread segments within the central apertures (711) of the driven gears (71) mesh respectively with the outer thread segments formed on the tie bars (28) to conduct helical motion, so that the movable platen (32) assembled with the driven gears (71) generates movement in up-down direction. In this manner, the opening stroke between the upper die (33) and the lower die (34) can be adjusted according to the height of the final product so as to be adapted to the manufacturing of products of any height. Moreover, implementation effect of the angled-outward toggle clamping vertical injection molding machine of the present invention can be increased.

What is claimed is:

1. A angled-outward toggle clamping type vertical injection molding machine, comprising:
a frame having a platen support attached thereto;
a angled-outward toggle mechanism, including a first coupling seat both sides of which are pivotally connected respectively to one ends of corresponding first toggle arms, the other ends of both first toggle arms being pivotally connected respectively to one ends of corresponding second toggle arms, and the other ends of both second toggle arms being pivotally connected respectively to a second coupling seat; the second toggle arms being pivotally connected respectively with one ends of corresponding third toggle arms, and the other ends of the third toggle arms being pivotally connected respectively to the two sides of an interlocking seat which is attached with a hydraulic cylinder at the middle portion thereof, the end of an output rod of the hydraulic cylinder being fixed to the second coupling seat, one ends of tie bars being correspondingly fixed to the two sides of the first coupling seat, and the other ends of the tie bars being extended upward to pass through and fit in the interlocking seat, and then to pass out of a stationary platen and the platen support so as to be located above the platen support;
a die unit, including the stationary platen, a movable platen, an upper die and a lower die; the stationary die being fastened to the platen support of the frame, and the second coupling seat of the angled-outward toggle mechanism being fixed to the bottom end of the stationary platen; the movable platen has its four corners to be fitted with the other ends of the tie bars protruding above the platen support; further, the bottom end of the movable platen being fixed to the upper die, and the lower die being attached to the upper end of the stationary platen so as to correspond to the upper die;
a stroke adjustment unit assembled at the upper end of the movable platen which has bush apertures provided at four corners thereof for fitting with the tie bars of the angled-outward toggle mechanism, and a number of driven gears being provided at the upper end of the movable platen, the driven gears having central apertures corresponding respectively to the bush apertures of the movable platen;
inner threaded segments being formed respectively in the central aperture, that mesh respectively with outer threaded segments formed on the tie bars; a drive gear being provided at the center of the driven gears and mated therewith; a rotational power source being provided on the movable platen the output shaft of which is assembled with a transmission gear for mating with the drive gear.

2. The angled-outward toggle clamping type vertical injection molding machine as claimed in claim 1, further comprising a die shift unit that includes at least two slide channels formed on the upper end of the stationary platen, and the intersection of said at least two slide channels corresponding precisely to the position of the upper die so that the lower die can be positioned at that intersection to correspond to the upper die; the platen support being formed with transport platforms having slide channels provided thereon, and the slide channels of the transport platforms being respectively aligned with the slide channels of the stationary platen; each of the transport platforms carrying one lower die, and each of the transport platforms being connected with a displacement power unit.

3. The angled-outward toggle clamping type vertical injection molding machine as claimed in claim 2, further comprising ejector units installed respectively at the slide channels of the transport platforms and are located below the transport platforms.

4. The angled-outward toggle clamping type vertical injection molding machine as claimed in claim 3, further comprising an injection unit assembled at the upper end of the movable platen in such a manner that the nozzle of a barrel of the injection unit corresponds to the sprue of the upper die.

5. The angled-outward toggle clamping type vertical injection molding machine as claimed in claim 2, further comprising an injection unit assembled at the upper end of the movable platen in such a manner that the nozzle of the barrel of the injection unit corresponds to the sprue of the upper die.

6. The angled-outward toggle clamping type vertical injection molding machine as claimed in claim 1, further comprising an injection unit assembled at the upper end of the movable platen in such a manner that the nozzle of the barrel of the injection unit corresponds to the sprue of the upper die.
